(19) United States
(12) Patent Application Publication
(10) Pub. No.: US 2004/0034849 A1
(43) Pub. Date: Feb. 19, 2004

(54) Volume image views and methods of creating volume images in which a file similar to a base file is stored as a patch of the base file

(75) Inventors: Jason Cohen, Seatac, WA (US); Bruce L. Green, Sammamish, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/641,798

(22) Filed: Aug. 15, 2003

Related U.S. Application Data
(63) Continuation-in-part of application No. 10/173,297, filed on Jun. 17, 2002.

(51) Int. Cl. G06F 9/44

(52) U.S. Cl. 717/120

(57) ABSTRACT

A first image of a first software which can be combined with other images of other software such that any one or more of the images can be restored from the volume image, and methods relating thereto. The method of making the volume image comprises creating a first image from a first software, creating a second image from the second software, and combining the first image and the second image into the volume image. Each image includes first descriptive data (metadata) corresponding to descriptive data of its software and includes file data corresponding to file data of its software.

### CROSS REFERENCE TO RELATED APPLICATIONS

This application is a continuation in part of co-pending U.S. patent application entitled “COMBINED IMAGE VIEWS AND METHODS OF CREATING IMAGES” filed Jun. 17, 2002, Ser. No. 10/173,297, which is incorporated herein by reference.

### TECHNICAL FIELD

The present invention relates to the field of disk imaging. In particular, this invention relates to a system and method for collapsing multiple individual images into a single volume image using patching to reduce image size and from which each of the individual images may be re-created.

### BACKGROUND OF THE INVENTION

Individual software images each include a large amount of data. In general, software images are increasing in size and take up increasingly large amounts of persistent and/or non-persistent storage space for a given computer. Historically, this size has grown at an exponential rate. For example, in certain cases there is a need to capture a copy of an installed operating system, applications, utilities, or other data (sometimes referred to as “capturing a volume”). One purpose of the captured copy is for creating an image including data that can be reused at a later date, such as by being redistributed to other computers. Frequently, there is a tremendous amount of space taken up by the captured copy and its data. Usually, multiple images are copied onto a single computer-readable media. These multiple images on the same media differ typically in only certain respects, e.g., based on the language of the installed OS, which applications (and versions of those applications) are included on that image, etc. Some multiple images are merely different SKUs or editions of the same program. The result is that the majority of the data in those multiple images is very similar (e.g., a substantial amount of the data is common to two or more images) but not exactly the same, creating a large amount of redundant space across images on the same media, which space could be used for other information.

For these reasons, a system and method for reducing the amount of redundant space is desired to address one or more of these and other disadvantages. There is a need to provide the smallest possible image size that still preserves all of the original data from the captured volume. This need for the smallest possible image size allows fitting large images onto compact discs and into memory for RAM-based scenarios, and allows for decreasing network storage and bandwidth requirements. One of the benefits of obtaining the smallest possible image size is that the image is strategically beneficial to customers of computers and/or software programs.

### SUMMARY OF THE INVENTION

There is a need to provide the smallest possible image size that still preserves all of the original data from the captured volume. This need for the smallest possible image size allows fitting large images onto compact discs and into memory for RAM-based scenarios, and allows for decreasing network storage and bandwidth requirements. One of the benefits of obtaining the smallest possible image size is that it is strategically beneficial to end-users of software and hardware.

The invention includes, in one aspect, a software image combining method that collapses multiple individual software programs (images) into a single operational, volume image file from which each of the individual programs can be recreated. In another aspect, the invention provides a solution to the problems in the prior art by creating a single operational, volume image from multiple individual images by (1) separating the descriptive data (e.g., metadata) describing the files within each individual image from the actual data of the files themselves, (2) separating data within each individual image that is common across multiple images and (3) using patches to reconstruct similar binary files. Each of the descriptive data of each individual image is included in the volume image whereas only a single copy of the common data and/or a delta file is included in the volume image. This reduces the size of the volume image because the common data and similar data, other than the patch, is not duplicated. The new volume image contains descriptive data (metadata) distinguishing each image within a single image file as well as a store of bits distinguishing common files, delta files and files unique to each image.

One implementation of the invention is to minimize the storage requirements of individual, different applications that run on a common operating system version. According to the invention, these individual, different applications can be combined or collapsed into a single, volume image. The volume image permits the mounting, modifying, updating, or restoring the image view of each of the individual, different applications as if each was individually, separately stored. The software functionality of the invention allows multiple single file images to be combined into one image file to take advantage of similar and/or common files.

In one form, the invention comprises a computer-readable medium having stored thereon volume image including a first image of a data structure of a first software and a second image of a data structure of a second software, which first and second images have been combined into the volume image so that the first image and/or second image of the volume image can each be re-created by imaging from the volume image. The volume image comprises:

an image of descriptive data of the first software;

an image of file data of the first software;

an image of descriptive data of the second software;

an image of the file data of the second software excluding certain file data; and

an image of a delta file which, when combined with one or more file data of the first image, corresponds to the excluded certain file data of the second software.

In another form, the invention comprises a volume image including a first image of a first software and including a second image of a second software, the volume image comprising:

a header of the volume image;

a first metadata of the first image;

a second metadata of the second image;

a first file data of file data of the first image and not of the second image;

a delta file data of file data of differences between the second image and the first image; and

a signature of the volume image whereby the first image and/or the second image can be imaged from the volume image and whereby the size of the volume image is less than the total size of the first image and the second image.

In another form, the invention comprises a computer readable medium having volume image including a first image of a first software and including a second image of a second software, the volume image comprising:

a header of the volume image;

a first metadata of the first image;

a second metadata of the second image;

a first file data of file data of the first image and not of the second image;

a delta file data of file data of differences between the second image and the first image; and

a signature of the volume image whereby the first image and/or the second image can be imaged from the volume image and whereby the size of the volume image is less than the total size of the first image and the second image.

In another form, the invention comprises a method comprising:

creating a first binary file from a first software, the first binary file including first binary file data corresponding to file data of the first software;

creating a second binary file from a second software, the second binary file including second binary file data corresponding to file data of the second software;

creating a delta file of the differences between the first binary file and the second binary file; and

combining the first binary file and the delta file into a volume image.

In another form, the invention comprises a method of combining a first plurality of binary files of a first image and a second plurality of binary files of a second image, wherein the first and second plurality include common file data, into a single volume image from which the first image and the second image can each be re-created by imaging, the method comprising:

identifying the common file data in both the first plurality and the second plurality;

separating the first image into a first header, a first metadata, a first file data, the common file data and a first signature;

separating the second image into a second header, a second metadata, a second file data, the common file data, a second signature and a delta file of the differences between one or more files of the first plurality of binary files and one or more files of the second plurality of the binary files;

combining the first metadata, the second metadata, the first file data, the second file data, the common file data and the delta file into a single image which comprises the single volume image having a header and a signature.

In another form, the invention comprises a method of combining a first software and a second software into a single volume image from which a first image of the first software and a second image of the second software can each be re-created by imaging, the method comprising:

converting the first software into a base image having metadata pointing to a plurality of files;

generating a combined digest of all files of the base image;

converting the second software into a second image having metadata pointing an offset table pointing to a plurality of files;

searching the combined digest for an exact match with one or more files in the second image;

updating the metadata of the second image and the offset table of the combined image to point to exactly matched files;

searching the metadata of the metadata for a similar match with the metadata of the second image;

generating and storing a patch as part of the combined image for similarly matched files; and

storing files of the second image which do not exactly match and which do not similarly match as part of the combined image.

In another form, the invention comprises a method of restoring to a computer readable medium a second image from a volume image having a first image and the second image wherein the volume image includes common data common to both the first image and the second image, second file data specific to the second image and not the first image, first similar file data of the first image similar to second similar file data of the second image, a delta file indicating the differences between the first similar file data and the second similar file data, the method comprising:

copying to the computer readable medium the common file data;

copying to the computer readable medium the second file data;

copying to the computer readable medium the first similar file data; and

applying the delta file to the copied first similar file data to yield the second similar file data.

In another form, the invention comprises a method of restoring to a computer readable medium a second image from a volume image having a first image and the second image wherein the volume image includes second file data specific to the second image and not the first image, first similar file data of the first image similar to second similar file data of the second image, a delta file indicating the differences between the first similar file data and the second similar file data, the method comprising:

copying to the computer readable medium the second file data;

copying to the computer readable medium the first similar file data; and

applying the delta file to the copied first similar file data to yield the second similar file data.

In another form, the invention comprises a method of combining onto a computer readable medium a first image and a second image into a volume image from which the first image and/or the second image may be separately restored wherein the first image includes:

common data common to both the first image and the second image, first file data specific to the first image and not the second image, the first file data including first similar file data similar to second similar file data of the second image; and

wherein the second image includes:

common data common to both the first image and the second image,

second file data specific to the second image and not the first image, the second file data including second similar file data similar to the first similar file data of the first image;

the method comprising:

copying the common data to the computer readable medium;

copying the first file data to the computer readable medium;

copying the second file data to the computer readable medium except for the second similar file data;

generating a delta file indicating the differences between the second similar file data and the first similar file data; and

copying the generated delta file to the computer readable medium.

In another form, the invention comprises a method of combining a first software and a second software into a single volume image from which a first image of the first software and a second image of the second software can each be re-created by imaging, the method comprising:

converting the first software into a base image having metadata pointing to a plurality of files;

generating a combined digest of all files of the base image;

converting the second software into a second image having metadata pointing an offset table pointing to a plurality of files;

searching the metadata of the metadata for a similar match with the metadata of the second image; and

generating and storing a patch as part of the combined image for similarly matched files.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary embodiment of the invention illustrating schematically the layout of image 1 and of image 2 which may be combined into a combined image to take advantage of single instance storage of the common files, as described in co-pending U.S. patent application entitled “COMBINED IMAGE VIEWS AND METHODS OF CREATING IMAGES” filed Jun. 17, 2002, Ser. No. 10/173,297, which is incorporated herein by reference.

FIG. 2 is an exemplary flow chart illustrating operation of a method according to the invention for combining two binary files.

FIG. 3 is an exemplary embodiment of the invention illustrating schematically the layout of image 1 and of image 2 which may be combined into a volume image including a delta file and, optionally, any common files.

FIG. 4 is an exemplary flow chart illustrating operation of a method according to the invention for creating a volume image.

FIG. 5 is a block diagram illustrating an exemplary computer-readable medium on which the volume image may be stored so that image 1 can be restored by imaging to a separate computer-readable medium and so that image 2 can be restored by imaging to another separate computer-readable medium, according to the invention.

FIG. 6 is an exemplary flow chart illustrating operation of a method according to the invention for unpacking a volume image.

FIG. 7 is an exemplary flow chart illustrating operation of a method according to the invention for creating a volume image having both common files and patched files.

FIG. 8 is a block diagram illustrating one example of a suitable computing system environment in which the invention may be implemented.

Corresponding reference characters indicate corresponding parts throughout the drawings.

### DETAILED DESCRIPTION OF THE INVENTION

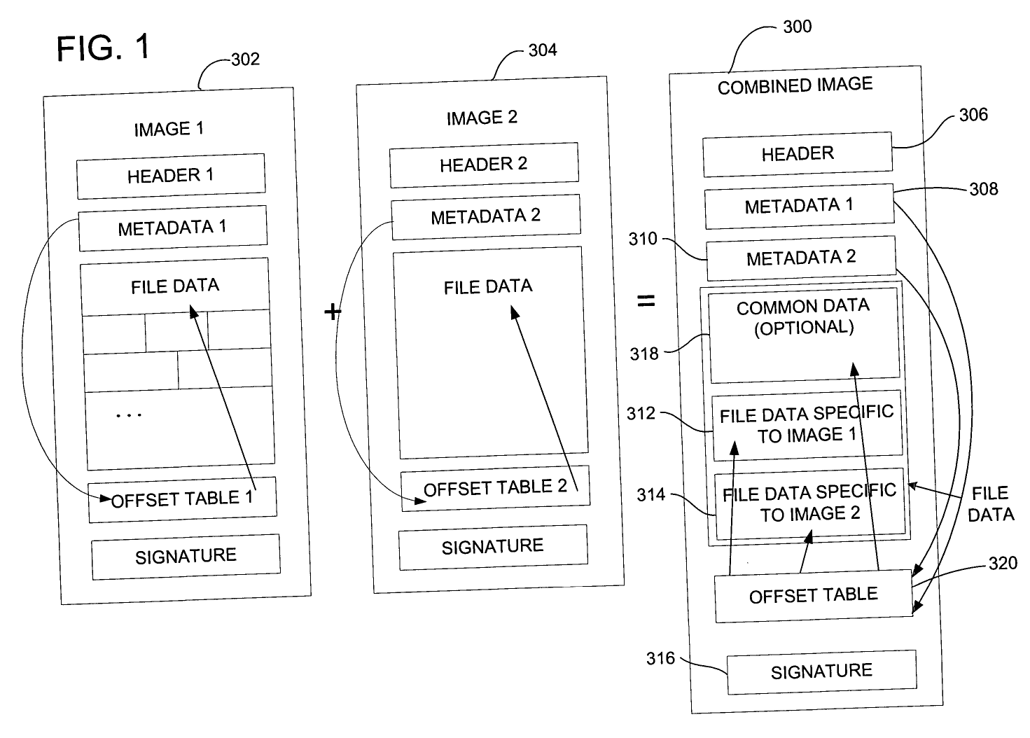

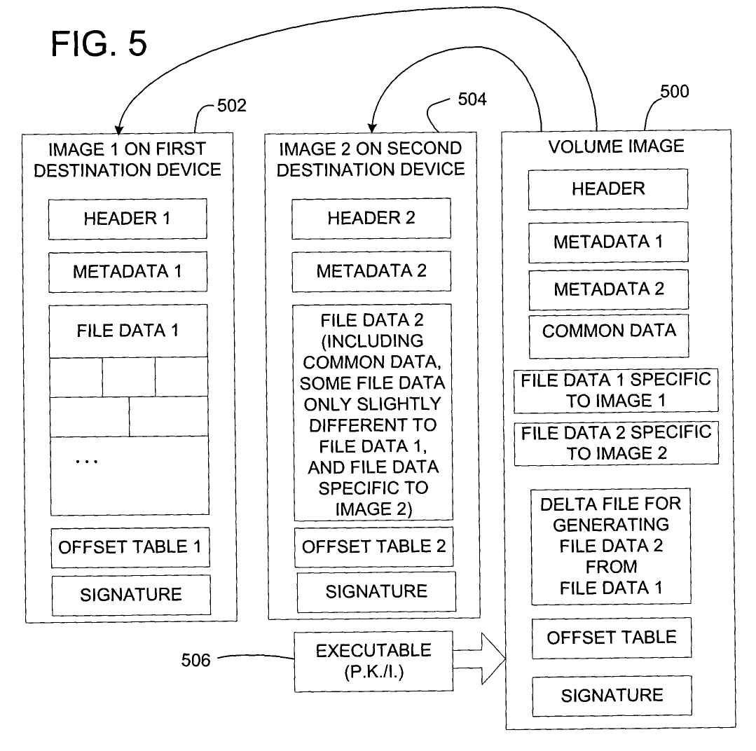

As shown in FIG. 1, a combined image 300 according to co-pending U.S. application entitled “COMBINED IMAGE VIEWS AND METHODS OF CREATING IMAGES” (filed Jun. 17, 2002, Ser. No. 10/173,297) includes a first image 302 of a first software and the second image 304 of a second software. The combined image includes a header 306 of the combined image 300, a first metadata 308 corresponding to the first image 302, a second metadata 310 corresponding to the second image 304, a first file data 312 of file data of the first image 302 and not of the second image 304, a second file data 314 of file data of the second image 304 and not of the first image 302, and an offset table 320 (describing where all the file data is in the combined image) and a signature 316 of the combined image 300. In cases where the first image 302 and the second image 304 have some of the same file data, such common data 318 is only copied once to the combined image. As a result, the size of the combined image 300 is less than the total size of the first image 302 and the second image 304. One advantage of the combined image 300 is that the first image 302 and/or the second image 304 can be restored from the combined image 300, as will be described below in greater detail with respect to FIG. 5.

As illustrated in FIG. 1, a method of creating the combined image 300 includes first creating the first image 302 from the first software, and creating the second image 304 from the second software followed by combining the first image 302 and the second image 304 into the combined image 300. As noted above and as illustrated in FIG. 1, the first image 302 includes first descriptive data (metadata 1) corresponding to descriptive data of the first software which points to the offset table (offset table 1) which points to first file data corresponding to file data of the first software. Similarly, the second image 304 includes second descriptive data (metadata 2) corresponding to descriptive data of the second software which points to the offset table (offset table 2) which points to second file data corresponding to file data of the second software. In cases where the first and second images both include at least some common file data 318, the combined image 300 includes only one copy of the common file data 318.

In a case where two images or more than two images are to be combined and it is known that the images have common file data, the following approach may be employed. Initially, the common file data of both the first and second images would be identified. The first image 302 would be separated into a first header, a first metadata, a first file data, the common file data, a first offset table and a first signature. Similarly, the second image 304 would be separated into a second header, a second metadata, a second file data, the common file data, a second offset table and a second signature. In order to create the combined image, the following would be combined: the first metadata, the second metadata, the first file data, the second file data, and the common file data into a single image which comprises the single combined image. A header, an offset table and a signature would then be added to the combined image 300. As a result, the combined image 300 includes first descriptive data (metadata 1) 308 corresponding to descriptive data of the first software which points to a combined image offset table 320 which points to file data 312 specific to image 1 and to common data 318. The file data 312 and the common data 318 correspond to the file data of the first software. In addition, the combined image 300 includes second descriptive data (metadata 2) 310 corresponding to descriptive data of the second software which points to the combined image offset table 320 which points to file data 314 specific to image 2. The filed data 314 and the common data 318 correspond to file data of the second software.

It is contemplated that a list of identifiers such as a hash of each of the files may be created and used in the process of combining the first image 302 and the second image 304. Initially, a list of identifiers (e.g., a hash) of the files in the combined image 300 would be created. For each of the file data in the first image 302, a file data of the first image 302 would be read and an identifier would be associated with each read file based on the contents of the file data. For each of the file data of the second image, a file data of the second image 304 would be read and for each read file an identifier would be associated with each of the read files based on the contents of the file data. In this situation, the read file data would be combined or added to the combined image 300 when the identifier of the read file is not in the list of identifiers of the combined image 300. As a new file is added to the combined image 300, the descriptive data (metadata 1 and/or metadata 2) would be updated to include the identification of the new file data which was added to the combined image 300 and the offset table would be updated to include the new location of the new file data. The identification of each file must be unique so that it does not collide with the identification of other files. In this regard, each file identification is verified as unique and modified to be unique if it is not before the metadata is updated.

Although FIG. 1 illustrates the combining images 1 and 2 into a combined image, the combined image 300 may not have a reduced size. For example, if little or no common data exists between the images, the combined image will be about the same size as the size of image 1 plus the size of image 2. In addition, FIG. 1 does not take into account the possibility of combining two binary files that may be very similar and have only slight differences. If files are only slightly different, (as in the case of QFEs, service packs, or different languages), the image still grows by the total size of the unique file. In general, a first file is considered similar to a second, stored file, if the first and second files include a substantial amount of the data that is common to both the first and second files but both files also include some data that not exactly the same.

According to the invention, two or more similar files of a volume image are identified so that similarities are only stored once. Additionally, differences between the stored file and other similar files are stored. The first step determines if files that are different are similar to other files within the volume image. This determination should be quick, so as to not adversely affect speed when capturing and comparing thousands of files. Some examples of matching criteria could be files with the same name, creation date, similar file size, or other matching criteria. Once a potential match is found, patching technology generates a delta file. This delta file, if smaller than the original file, will be stored within the image instead of the original file. If multiple matches are found, then the smallest combination of base file and delta files will be stored within the image. The resulting image metadata for all file instances will contain a base file identifier and an optional delta file identifier if the file was stored via patching. Upon restoration of the files, any files that were stored using patching would be restored by combining the base file and the appropriate delta file entry. Note that these delta files can also be stored once (single-instance) for duplicate files within the image or images. For example, this delta file may be created as indicated in U.S. Pat. Nos. 6,216,175, 6,243,766, 6,449,764, 6,496,974, 6,466,999, 6,493,871, 5,745,313 and 6,381,742 relating to updating and patching and co-pending U.S. application Ser. No. 09/561447 Apr. 28, 2000 Method and System for Updating Software with Smaller Patch Files.

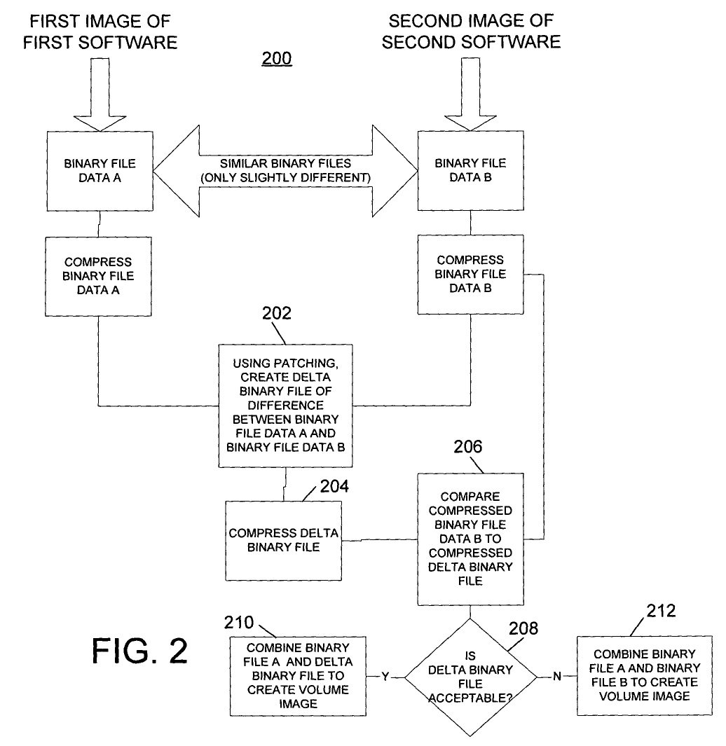

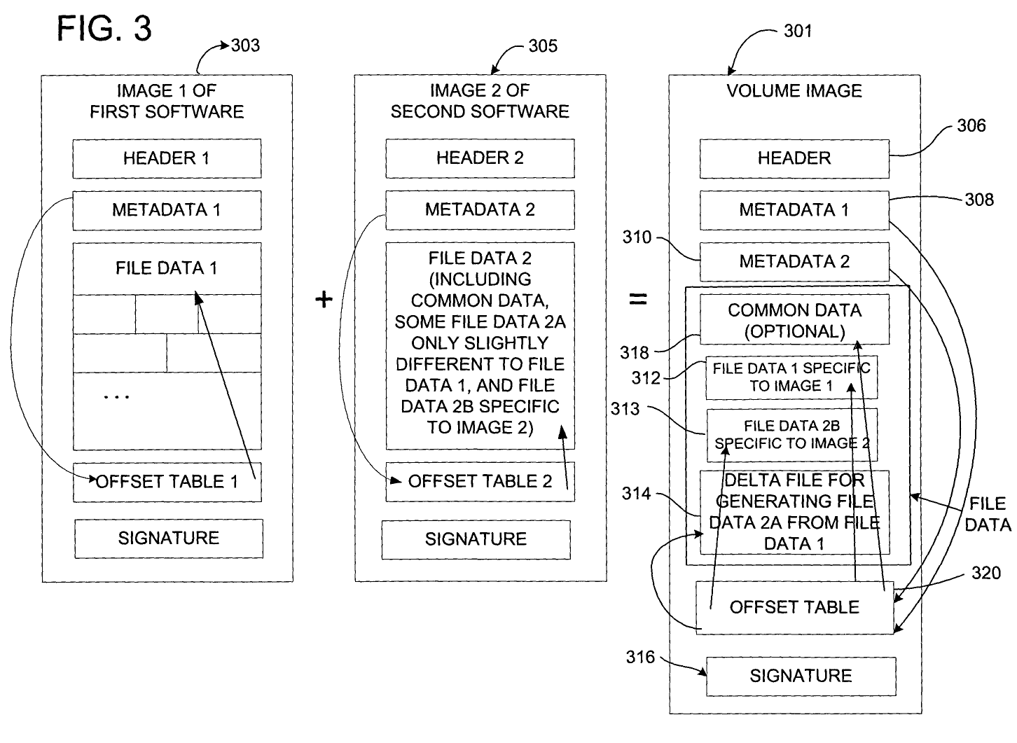

Referring to FIG. 2, a method 200 of combining two similar files is shown, according to the invention. Although this method 200 may be implemented as instructions which are part of a program stored on a computer readable medium, those skilled in the art will recognize other ways for implementing this method 200. In particular, binary file data A which is part of a first image of first software may be similar to binary file B which is part of a second image of a second software. Assuming the first and second images will be combined into a single volume image (see FIG. 3), both files A and B will end up on the same media. Since these files are similar and only slightly different, patching technology may be used. In particular, after the binary files are compressed, a patching algorithm is used to create at delta binary file at 202. Any algorithm may be employed to generate the delta file. For example, the patching technique described in patents and application noted above may be used.

The delta file identifies the differences between binary file data A and binary file data B. In other words, applying the delta file to file data A yields file data B (or visa versa). At 204, the delta binary file is compressed. At 206, the size of the compressed delta binary file is compared to compressed binary file data B. Based on this comparison, a determination is made at 208 to determine whether the delta binary file is acceptable. This determination may simply include a comparison of the size of the compressed delta binary file as compared to the size of binary file data B which the delta binary file is intended to replace or it may include other comparisons such as restoration time. If the size of the delta binary file is smaller (e.g., at least 25% smaller), this means that the combination of file data A and the delta binary file will be smaller than the combination of file data A and file data B. Thus, the delta binary file is acceptable and at 210 file data A and the delta file are stored as part of the volume image because they would be smaller that file data A plus file data B. If the size of the delta binary file is near the size of or larger that file data B, this means that the combination of file data A and the delta binary file will be larger than the combination of file data A and file data B. Thus, the delta binary file is unacceptable and at 212 file data A and file data B are stored as part of the volume image because they would be smaller that file data A plus the delta binary file.

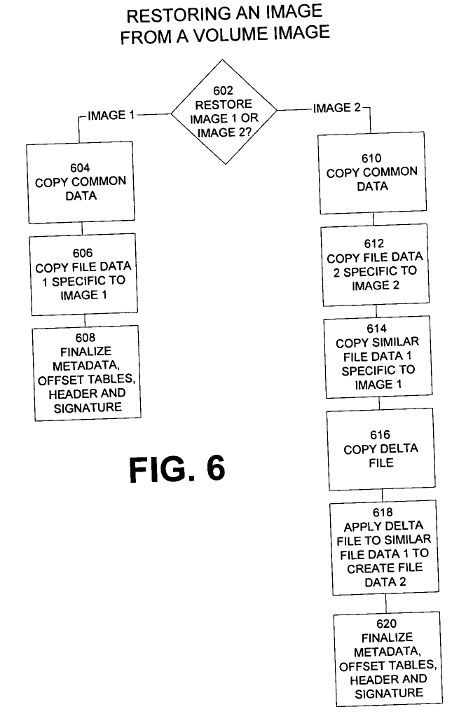

As shown in FIG. 3, a volume image 301 includes a first image 303 of a first software and the second image 305 of a second software. The volume image includes a header 306 of the volume image 301, a first metadata 308 corresponding to the first image 303, a second metadata 310 corresponding to the second image 305, a first file data 312 of file data specific to the first image 303 and not of the second image 305, a second file data 2B 313 of file data specific to the second image 305 and not of the first image 303, a delta file 314 for generating file data 2A from file data 1, an offset table 320 and a signature 316 of the volume image 301. In cases where the first image 303 and the second image 305 have some of the same file data, such common data 318 is only copied once to the volume image. As a result, the size of the volume image 301 is less than the total size of the first image 303 and the second image 305. One advantage of the volume image 301 is that the first image 303 and/or the second image 305 can be restored from the volume image 301, as will be described below in greater detail with respect to FIGS. 5 and 6.

As illustrated in FIG. 3, a method of creating the volume image 301 includes first creating the first image 303 from the first software, and creating the second image 305 from the second software followed by combining the first image 303 and the second image 305 into the volume image 301. As noted above and as illustrated in FIG. 3, the first image 303 includes first descriptive data (metadata 1) corresponding to descriptive data of the first software which points to the offset table (offset table 1) which points to first file data corresponding to file data of the first software. Similarly, the second image 305 includes second descriptive data (metadata 2) corresponding to descriptive data of the second software which points to the offset table (offset table 2) which points to second file data corresponding to file data of the second software. In cases where the first and second images both include at least some common file data 318, the volume image 301 includes only one copy of the common file data 318.

In a case where two images or more than two images are to be combined and it is known that the images have common file data and/or similar file data, the following approach may be employed. Initially, the common file data and the similar file data of both the first and second images would be identified. The first image 303 would be separated into a first header, a first metadata, a first file data, the common file data, a first offset table and a first signature. Similarly, the second image 305 would be separated into a second header, a second metadata, a second file data, the common file data, the similar file data, a second offset table and a second signature. In order to create the volume image, the following would be combined: the first metadata, the second metadata, the first file data, the second file data, the common file data and a delta file into a single image which comprises the single combined image. The delta file is generated by a patch and defines the difference between the similar file data of the second image and file data of the first image. A header, an offset table and a signature would then be added to the volume image 301. As a result, the volume image 301 includes first descriptive data (metadata 1) corresponding to descriptive data of the first software which points to the offset table which points to first file data and the common file data corresponding to file data of the first software. In addition, the volume image 301 includes second descriptive data (metadata 2) corresponding to descriptive data of the second software which points to the offset table which points to second file data and the common file data corresponding to file data of the second software. In addition, the volume image 301 includes a flag in the second descriptive data (metadata 2) which points to the delta file.

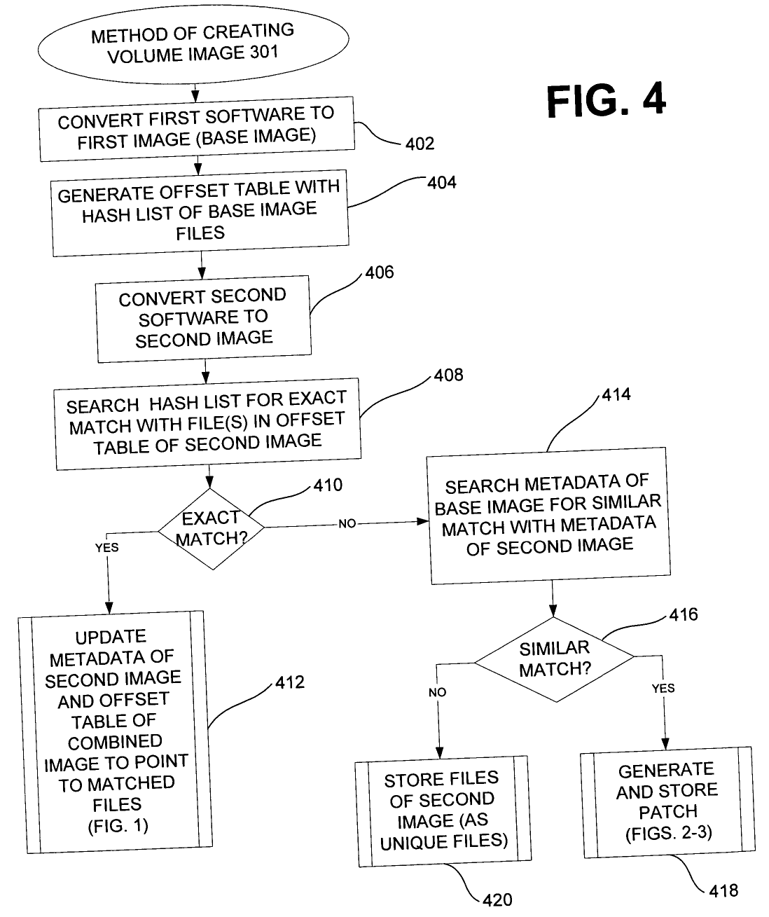

Although not illustrated in FIG. 3, it is contemplated that a list of identifiers such as a hash of each of the files may be created and used in the process of combining the first image 303 and the second image 305. Initially, a list of identifiers (e.g., a hash) of the files in the volume image 301 would be created. For each of the file data in the first image 303, a file data of the first image 303 would be read and an identifier would be associated with each read file based on the contents of the file data. For each of the file data of the second image, a file data of the second image 305 would be read and for each read file an identifier would be associated with each of the read files based on the contents of the file data. In this situation, the read file data would be combined or added to the volume image 301 when the identifier of the read file is not in the list of identifiers of the volume image 301. As a new file is added to the volume image 301, the descriptive data (metadata 1 and/or metadata 2) would be updated to include the identification of the new file data which was added to the volume image 301 and the offset table would be updated to include the new location of the new file data. The identifier of each file must be unique so that it does not collide with the identification of other files. In this regard, each file identification is verified as unique and modified to be unique if it is not before the metadata is updated. In addition, the identifier must allow similar files to be matched so that the generation of a delta file may be considered. For example, the identifier should allow files that are only slightly different (as in the case of QFEs, service packs, or different languages) to be recognized. Referring to FIG. 4, a method is illustrated of combining a first software and a second software into a single volume image 301 from which a first image 303 of the first software and a second image 305 of the second software can each be restored by imaging. Initially, the first software is converted into a base image having metadata pointing to its binary file data at 402. In general, the base image is the image to which files will be added and may be a pre-existing image or a newly created image. For example, pre-existing image 303 may be viewed as the base image to which image 305 would be added. A combined offset table including the hash list (e.g., a combined digest) of all the files identified by the metadata of the base image is next generated at 404. Next at 406, the second software is converted into a second image 305 including an offset table listing the files of the second image.

At 408, the hash list of the base image is searched for an exact match with one or more files in the offset table of the second image. At decision step 410, the software performing the operation determines whether the search at 408 has uncovered any exact matches. If the search uncovers an exact match, the software proceeds to 412 and updates the metadata of the second image and offset table of the combined image to point to the exactly matched files, as illustrated in FIG. 1.

If no exact match is found at 410, the software proceeds to 414 to search metadata of base image for similar match with metadata of second image. At decision step 416, the software performing the operation determines whether the search at 414 has uncovered any similar matches. If the search uncovers a similar match, the software proceeds to 418 to generate and store a patch as part of the combined image, as illustrated in FIGS. 2 and 3. If no similar match is found at 416, the software proceeds to 420 to store the files of the second image as unique files as part of the combined image.

Referring next to FIG. 5, this diagram illustrates one advantage according to the invention of creating a volume image 500 so that a first image 502 can be restored from the volume image 500 and/or a second image 504 can be restored from the volume image 500. One example where this advantage may be applicable is a software application which has different SKUs and/or editions for use with different operating systems. To a large extent, these various editions of software have a large amount of similar data. However, it has been the practice in the past to image each one of these editions separately. Thus, a vendor that was selling these various editions would be required to inventory each one of the editions separately on a separate computer-readable medium. According to one aspect of the invention, these various editions of the software may be combined into a single volume image 500 from which any one of the editions 502, 504 may be recreated. It is also contemplated that the volume image 500 may be used with an executable file 506 is part of an external set-up program or other tool for extracting an image. The file 506, when executed, extracts a particular one of the images used to create the volume image. It is further contemplated that the executable file may operate in response to a product key (P.K.) or an identifier (I.) associated with the software which is input by a user.

Referring to FIG. 6, a flow chart illustrates the process of restoring to a new computer readable medium (CRM) an image from the volume image 500 including image 1 502 and image 2 504 (see FIG. 5). At 602, it is determined which image will be restored. To restore image 1 to the new CRM, the common data is copied to the new CRM at 604 and the file data specific to image 1 is copied to the new CRM at 606. At 608, the metadata, offset table, header and signature of the image 1 on the new CRM are finalized. To restore image 2 to the new CRM, the common data is copied to the new CRM at 610 and the file data 2 specific to image 2 is copied to the new CRM at 612. At 614, the file data 1 specific to image 1 and similar to the file data of image 2 is copied to the CRM. This latter, similar file data 1 is the file data to which the delta files will be applied. At 616, the delta files are copied to the new CRM and at 618, these files applied to the similar file data 1. For example, the image 2 would be created with a flag directing the application of the delta file to another file. Currently, metadata entries have a unique identifier (noted above). For the delta patch, there would be another unique identifier in the metadata for that file. The files main unique identifier in the metadata would be the base file unique identifier. The “flag” would be the unique identifier for the patch data that must be combined with the base file to get back the original data. If in the metadata the file did not have a unique identifier for the patch data (or was zero), then the flag would not be set and it would operate as before. At 620, the metadata, offset table, header and signature of the image 2 on the new CRM are finalized.

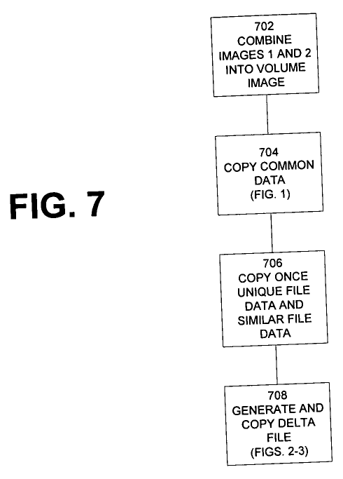

The following is one example of a summary of the process of FIG. 7 for capturing a volume image. In this process it is assumed at 702 that the volume image is a combination of images 1 and 2. It is also assumed that some of the files of images 1 and 2 are the same (e.g., redundant; common data) and that some of the files of images 1 and 2 are similar and can be replaced by a delta file, as noted above.

In particular, FIG. 7 illustrates a method of combining onto a CRM a first image and a second image into a volume image from which the first image and/or the second image may be separately restored. The first image includes common data common to both the first image and the second image and first file data specific to the first image and not the second image. The first file data also includes first similar file data similar to second similar file data of the second image. The second image includes common data common to both the first image and the second image and second file data specific to the second image and not the first image. The second file data includes second similar file data similar to the first similar file data of the first image.

At 704, for each current file to be captured to the volume image, a file hash is generated and used to determine if the current file has already been stored (e.g., the file to be copied from image 1 or image 2 to the CRM to create the volume image has already been copied to the CRM). If the file has already been stored, the metadata for the file is updated to point to the currently stored file entry. This process is illustrated in greater detail above, particularly in co-pending U.S. patent application entitled “COMBINED IMAGE VIEWS AND METHODS OF CREATING IMAGES” noted above and with regard to FIG. 1. Thus, the method includes at 704 copying the common data to the CRM.

At 706, if the file has not been stored yet, a list of candidate files of similar files is generated (e.g., using file name, date, or other criteria) and scanned to determine the best combination of total size (base file size plus patch size). All unique files (first file data and second file data but not including second similar file data) are copied once to the CRM. The metadata for the file instance is then updated to refer to the unique files. This process is illustrated in greater detail above, particularly with regard to FIGS. 1 and 3-5. Thus, the method includes copying the first file data to the CRM and copying the second file data to the CRM except that the second similar file data is not copied to the CRM.

At 708, a delta file indicating the differences between the second similar file data (which has not been copied to the CRM) and the first similar file data (which has been copied to the CRM) is generated. In addition, this delta file is copied to the CRM. Thus, the method includes generating a delta file indicating the differences between the second similar file data and the first similar file data and copying the generated delta file to the CRM.

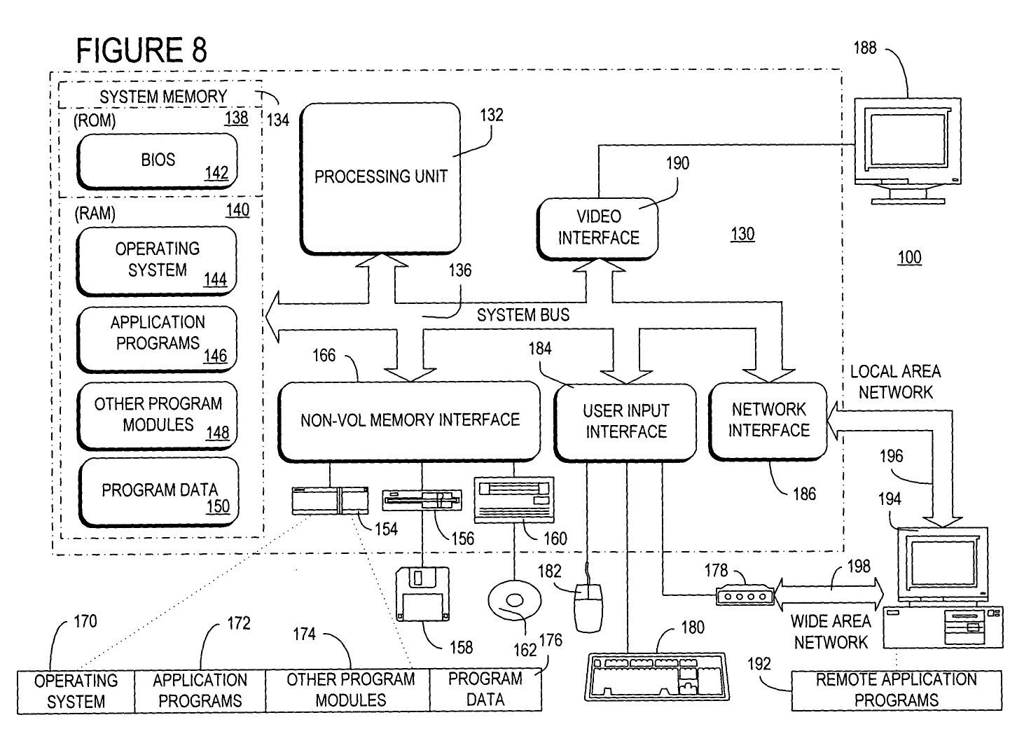

FIG. 8 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134 on which a volume image according to the invention may stored and/or individual images recreated from a volume image may be stored. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer-readable media. Computer-readable media, which include both volatile and nonvolatile media, removable and non-removable media, may be any available medium that can be accessed by computer 130. By way of example and not limitation, computer-readable media comprise computer storage media and communication media. Computer storage media include volatile and nonvolatile, removable and non-removable media implemented in any method or technology for storage of information such as computer-readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed by computer 130. Communication media typically embody computer-readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer-readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 8 illustrates operating system 144, application programs 146, other program modules 148, and program data 151.

The computer 130 may also include other removable/non-removable, volatile/nonvolatile computer storage media. For example, FIG. 8 illustrates a hard disk drive 154 that reads from or writes to non-removable, nonvolatile magnetic media. FIG. 8 also shows a magnetic disk drive 156 that reads from or writes to a removable, nonvolatile magnetic disk 158, and an optical disk drive 161 that reads from or writes to a removable, nonvolatile optical disk 162 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 144, and magnetic disk drive 156 and optical disk drive 161 are typically connected to the system bus 136 by a non-volatile memory interface, such as interface 166.

The drives or other mass storage devices and their associated computer storage media discussed above and illustrated in FIG. 8, provide storage of computer-readable instructions, data structures, program modules and other data for the computer 130. In FIG. 8, for example, hard disk drive 154 is illustrated as storing operating system 170, application programs 172, other program modules 174, and program data 176. Note that these components can either be the same as or different from operating system 144, application programs 146, other program modules 148, and program data 151. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 8 include a local area network (LAN) 196 and a wide area network (WAN) 198, but may also include other networks. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 194, or other appropriate mechanism. In a networked environment, program modules depicted relative to computer 130, or portions thereof, may be stored in a remote memory storage device (not shown). By way of example, and not limitation, FIG. 8 illustrates remote application programs 192 as residing on the memory device. It will be appreciated that the network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

In operation, computer 130 executes computer-executable instructions such as the executable file 506.

The following examples illustrate the invention. Windows brand XP Home and Windows brand XP Pro are different SKU numbers for applications with are very similar and which share a large amount of common data. The Home version is approximately 355MB and the Pro version is approximately 375MB. If both editions are separately copied onto a single media, about 730MB would be required. On the other hand, imaging the two editions as a single volume image results in a single volume image of about 390MB. Thus, the volume image saves over 300MB of disk/media. As an example of an OEM scenario, both the Home and Pro editions may be offered with or without Microsoft Office. If the editions are separately copied, Home without Office would require 355MB, Home with Office would require 505MB, Pro without Office would require 375MB and Pro with Office would require 525MB, for a total of 1760MB. On the other hand, imaging the four different offerings as a single volume image results in a single volume image of about 540MB. Thus, the volume image saves over 1100MB of disk/media.

This savings of disk/media translates into many advantages, as noted above. For example, the transmission or replication of images or a network or other link can be accomplished with less time or with reduced bandwidth.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A computer-readable medium having stored thereon volume image including a first image of a data structure of a first software and a second image of a data structure of a second software, which first and second images have been combined into the volume image so that the first image and/or second image of the volume image can each be re-created by imaging from the volume image, comprising:
an image of descriptive data of the first software;
an image of file data of the first software;
an image of descriptive data of the second software;
an image of the file data of the second software excluding certain file data; and
an image of a delta file which, when combined with one or more file data of the first image, corresponds to the excluded certain file data of the second software.

2. The medium of claim 1 wherein the descriptive data comprises metadata including one or more of the following: file names, attributes, file times, compression formats, locations and streams.

3. The medium of claim 1 wherein the file data comprises any binary file data or any other data other than metadata.

4. The medium of claim 1 wherein at least part of the file data of the first image and is the same as at least part of the file data of the second image and wherein the same file data only appears once within the volume image.

5. The medium of claim 1 further comprising modifying, updating or restoring file data and/or modifying the descriptive data to point to any modified, updated or restored file data.

6. The volume image of claim 1 wherein the first software or the second software includes an operating system, an application program or both.

7. The volume image of claim 1 wherein the first software and the second software are similar applications, wherein the first software is for use with a first operating system and wherein the second software is for use with a second operating system.

8. The volume image of claim 1 wherein the file data and the delta file are compressed.

9. A volume image including a first image of a first software and including a second image of a second software, said volume image comprising:
a header of the volume image;
a first metadata of the first image;
a second metadata of the second image;
a first file data of file data of the first image and not of the second image;
a delta file data of file data of differences between the second image and the first image; and
a signature of the volume image whereby the first image and/or the second image can be imaged from said volume image and whereby the size of the volume image is less than the total size of the first image and the second image.

10. The volume image of claim 9 further comprising a second file data of file data of the second image and not of the first image.

11. The volume image of claim 9 further comprising a common file data of file data of both the first image and the second image;

12. The volume image of claim 9 wherein the first metadata and the second metadata each include one or more of the following: file names, attributes, file times, compression formats, locations and streams.

13. The volume image of claim 9 wherein each of the first and second file data comprises any binary file data or any other data other than metadata.

14. The volume image of claim 9 further comprising modifying, updating or restoring file data and/or modifying an offset table to point to any modified, updated or restored file data.

15. The volume image of claim 9 wherein the first software or the second software includes an operating system, an application program or both.

16. The volume image of claim 9 wherein the first software and the second software are similar applications, wherein the first software is for use with a first operating system and wherein the second software is for use with a second operating system.

17. The volume image of claim 9 wherein the first file data and the delta file data are compressed data.

18. A computer readable medium having volume image including a first image of a first software and including a second image of a second software, said volume image comprising:
a header of the volume image;
a first metadata of the first image;
a second metadata of the second image;
a first file data of file data of the first image and not of the second image;
a delta file data of file data of differences between the second image and the first image; and
a signature of the volume image whereby the first image and/or the second image can be imaged from said volume image and whereby the size of the volume image is less than the total size of the first image and the second image.

19. A method comprising:
creating a first binary file from a first software, said first binary file including first binary file data corresponding to file data of the first software;
creating a second binary file from a second software, said second binary file including second binary file data corresponding to file data of the second software;
creating a delta file of the differences between the first binary file and the second binary file; and
combining the first binary file and the delta file into a volume image.

20. The method of claim 19 further comprising modifying, updating or restoring file data and/or modifying the descriptive data to point to any modified, updated or restored file data.

21. The method of claim 19 wherein the first and second software both include at least some common file data and wherein the volume image includes only one copy of at least some of the common file data.

22. The method of claim 19 wherein the binary file data comprises any binary file data or any other data other than metadata.

23. The method of claim 19 wherein the first software or the second software includes an operating system, an application program or both.

24. The method of claim 19 wherein the first software and the second software are similar applications, wherein the first software is for use with a first operating system and wherein the second software is for use with a second operating system.

25. The volume image of claim 19 wherein the first binary file and the delta file of the volume image are compressed.

26. A method of combining a first plurality of binary files of a first image and a second plurality of binary files of a second image, wherein the first and second plurality include common file data, into a single volume image from which the first image and the second image can each be re-created by imaging, the method comprising:
identifying the common file data in both the first plurality and the second plurality;
separating the first image into a first header, a first metadata, a first file data, the common file data and a first signature;
separating the second image into a second header, a second metadata, a second file data, the common file data, a second signature and a delta file of the differences between one or more files of the first plurality of binary files and one or more files of the second plurality of the binary files;
combining the first metadata, the second metadata, the first file data, the second file data, the common file data and the delta file into a single image which comprises the single volume image having a header and a signature.

27. The method of claim 26 wherein the metadata includes one or more of the following: file names, attributes, file times, compression formats, locations and streams.

28. The method of claim 26 wherein the file data comprises any binary file data or any other data other than metadata.

29. The method of claim 26 further comprising modifying, updating or restoring file data and/or modifying the metadata to point to any modified, updated or restored file data.

30. The method of claim 26 wherein the first software or the second software includes an operating system, an application program or both.

31. The method of claim 26 wherein the first software and the second software are similar applications, wherein the first software is for use with a first operating system and wherein the second software is for use with a second operating system.

32. The method of claim 26 wherein at least part of the file data of the first image and is the same as at least part of the file data of the second image and wherein the same file data only appears once within the volume image.

33. The method of claim 26 wherein the file data and the delta file of the single image are compressed.

34. A method of combining a first software and a second software into a single volume image from which a first image of the first software and a second image of the second software can each be re-created by imaging, the method comprising:
converting the first software into a base image having metadata pointing to a plurality of files;
generating a combined digest of all files of the base image;
converting the second software into a second image having metadata pointing an offset table pointing to a plurality of files;
searching the combined digest for an exact match with one or more files in the second image;
updating the metadata of the second image and the offset table of the combined image to point to exactly matched files;
searching the metadata of the metadata for a similar match with the metadata of the second image;
generating and storing a patch as part of the combined image for similarly matched files; and
storing files of the second image which do not exactly match and which do not similarly match as part of the combined image.

35. The method of claim 34 wherein the metadata comprises one or more of the following: file names, attributes, file times, compression formats, locations and streams.

36. The method of claim 34 wherein the file data comprises any binary file data or any other data other than metadata.

37. The method of claim 34 further comprising modifying, updating or restoring file data and/or modifying the metadata of the first image to point to any modified, updated or restored file data.

38. The method of claim 34 wherein the first software or the second software includes an operating system, an application program or both.

39. The method of claim 34 wherein the first software and the second software are similar applications, wherein the first software is for use with a first operating system and wherein the second software is for use with a second operating system.

40. The method of claim 34 wherein the first image and the second image include similar file data and common file data.

41. The method of claim 34 wherein at least part of the file data of the first image and is the same as at least part of the file data of the second image and wherein the same file data only appears once within the volume image.

42. The method of claim 34 wherein the files and the patch of the combined image are compressed.

43. A method of restoring to a computer readable medium a second image from a volume image having a first image and the second image wherein the volume image includes common data common to both the first image and the second image, second file data specific to the second image and not the first image, first similar file data of the first image similar to second similar file data of the second image, a delta file indicating the differences between the first similar file data and the second similar file data, said method comprising:
copying to the computer readable medium the common file data;
copying to the computer readable medium the second file data;
copying to the computer readable medium the first similar file data; and
applying the delta file to the copied first similar file data to yield the second similar file data.

44. The medium of claim 43 wherein the file data comprises any binary file data or any other data other than metadata.

45. The medium of claim 43 wherein the first image or the second image includes an operating system, an application program or both.

46. A method of restoring to a computer readable medium a second image from a volume image having a first image and the second image wherein the volume image includes second file data specific to the second image and not the first image, first similar file data of the first image similar to second similar file data of the second image, a delta file indicating the differences between the first similar file data and the second similar file data, said method comprising:
copying to the computer readable medium the second file data;
copying to the computer readable medium the first similar file data; and
applying the delta file to the copied first similar file data to yield the second similar file data.

47. The method of claim 46 wherein the file data comprises any binary file data or any other data other than metadata.

48. The method of claim 46 wherein the first image or the second image includes an operating system, an application program or both.

49. A method of combining onto a computer readable medium a first image and a second image into a volume image from which the first image and/or the second image may be separately restored wherein the first image includes:
common data common to both the first image and the second image, first file data specific to the first image and not the second image, said first file data including first similar file data similar to second similar file data of the second image; and
wherein the second image includes:
common data common to both the first image and the second image,
second file data specific to the second image and not the first image, said second file data including second similar file data similar to the first similar file data of the first image;
said method comprising:
copying the common data to the computer readable medium;
copying the first file data to the computer readable medium;
copying the second file data to the computer readable medium except for the second similar file data;
generating a delta file indicating the differences between the second similar file data and the first similar file data; and
copying the generated delta file to the computer readable medium.

50. The method of claim 49 wherein the file data comprises any binary file data or any other data other than metadata.

51. The method of claim 49 wherein the first image or the second image includes an operating system, an application program or both.

52. A method of combining a first software and a second software into a single volume image from which a first image of the first software and a second image of the second software can each be re-created by imaging, the method comprising:
converting the first software into a base image having metadata pointing to a plurality of files;
generating a combined digest of all files of the base image;
converting the second software into a second image having metadata pointing an offset table pointing to a plurality of files;
searching the metadata of the metadata for a similar match with the metadata of the second image; and
generating and storing a patch as part of the combined image for similarly matched files.
